(19) United States
(12) Patent Application Publication
(10) Pub. No.: US 2026/0237209 A1
(43) Pub. Date: Aug. 13, 2026

(54) SCALABLE AUTOREGRESSIVE VIDEO TOKENIZER

(71) Applicant: NVIDIA Corporation, Santa Clara, CA (US)

(72) Inventors: Songwei Ge, Greenbelt, MD (US); Xian Liu, Bellevue, WA (US); Jinwei Gu, Sunnyvale, CA (US); Haoxiang Wang, Foster City, CA (US); Fitsum Reda, Santa Clara, CA (US); Ming-Yu Liu, Redwood City, CA (US); Yogesh Balaji, San Jose, CA (US)

(21) Appl. No.: 19/455,747

(22) Filed: Jan. 21, 2026

Related U.S. Application Data
(60) Provisional application No. 63/756,542, filed on Feb. 10, 2025.

(51) Int. Cl. G06V 20/40; G06V 10/774

(52) U.S. Cl. CPC G06V 20/46; G06V 10/774

(57) ABSTRACT

An autoregressive (AR) tokenizer can be a transformer-based architecture that tokenizes high-resolution, long-duration videos with a compression ratio and preserved reconstruction quality. Instead of directly quantizing inputs, the disclosed processes can use continuous tokens from the previous frame as inputs for the current frame. By bypassing the quantization layer for these continuous tokens, the video quality can be enhanced during reconstruction compared to conventional solutions. AR tokenizer can exploit the temporal causality between video frames by conditioning each frame's decoding on previous frames'pre-bottleneck features, reducing the temporal redundancy, and improving the reconstruction quality. While the performance of conventional transformer-based discrete tokenizers plateaus with increased training compute, the disclosed AR tokenizer can continue to improve, achieving an increase of 8 times the compression rate compared to conventional reconstruction algorithms.

### CROSS-REFERENCE

This application claims the benefit of U.S. Provisional Application Ser. No. 63/756,542, filed by Songwei Ge, et al., on Feb. 10, 2025, entitled “SYSTEM AND METHOD FOR QUANTIZED LANGUAGE-IMAGE PRETRAINING,” commonly assigned with this application and incorporated herein by reference in its entirety.

### TECHNICAL FIELD

This application is directed, in general, to video generation and, more specifically, to using video tokenization for video representation.

### BACKGROUND

Large language models (LLMs) are a type of language models that have been trained on massive amounts of text data and use deep learning to identify complex data patterns. Video, like language, is another important modality with abundant data across the web, and offers orthogonal knowledge about the physical world and motion dynamics. Training large-scale video generative models has thus sparked broad interest. Unlike language, the information contained in videos can be sparse, implicit, and highly redundant. Despite impressive progress, video generation can lag behind generative language and image models. Its redundant, sparse, and implicit nature obstructs the scalability of existing approaches. As a result, training video machine learning models (VMLMs), such as large-scale video generative models, multi-modal language models (MLMs), and Vision-Language Models (VLMs), is far behind the scale of training LLMs.

### SUMMARY

In one aspect, a method is disclosed. In one embodiment, the method includes (1) generating a set of first tokens of frames of a video using a convolutional tokenizer in a pixel space, wherein the set of first tokens corresponds to a perceptual compression of the frames of the video, (2) freezing the convolutional tokenizer from further processing, and (3) generating a set of second tokens from the set of first tokens using a video transformer tokenizer in a latent space, wherein the set of second tokens corresponds to a semantic compression of the frames of the video, and the set of second tokens is an encoding of the frames of the video into video tokens.

In a second aspect, a video tokenizer system is disclosed. In one embodiment, the video tokenizer system includes (1) convolutional encoder configured to generate a first set of video tokens from a training video utilizing a convolutional tokenizer in a pixel space corresponding to a perceptual compression of frames of the training video, (2) a transformer encoder configured to generate a second set of video tokens from the first set of video tokens utilizing a video transformer tokenizer in a latent space corresponding to a semantic compression of the frames of the training video, and (3) an autoregressive convolutional decoder configured to generate output frames utilizing the second set of video tokens.

In a third aspect, a system is disclosed. In one embodiment, the system includes (1) a receiver configured to receive input parameters, wherein the input parameters include a video and operation parameters, and (2) one or more processors, configured to execute code to generate a set of first tokens of frames of a video using a convolutional tokenizer in a pixel space, wherein the set of first tokens corresponds to a perceptual compression of the frames of the video, freeze the convolutional tokenizer from further processing when a last frame of the video has been tokenized in the set of first tokens, and generate a set of second tokens from the set of first tokens using a video transformer tokenizer in a latent space, wherein the set of second tokens corresponds to a semantic compression of the frames of the video, and the set of second tokens is an encoding of the frames of the video into video tokens.

In a fourth aspect, a non-transitory computer-readable medium storing a series of operating instructions that directs a data processing apparatus when executed thereby to perform operations is disclosed. In one embodiment, the operations include (1) generating a set of first tokens of frames of a video using a convolutional tokenizer in a pixel space, wherein the set of first tokens corresponds to a perceptual compression of the frames of the video, (2) freezing the convolutional tokenizer from further processing, and (3) generating a set of second tokens from the set of first tokens using a video transformer tokenizer in a latent space, wherein the set of second tokens corresponds to a semantic compression of the frames of the video, and the set of second tokens is an encoding of the frames of the video into video tokens.

### BRIEF DESCRIPTION

Reference is now made to the following descriptions taken in conjunction with the accompanying drawings, in which:

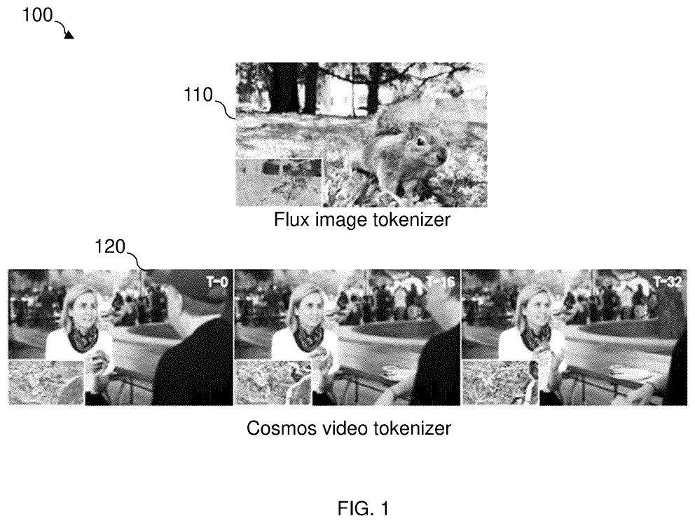

FIG. 1 is an illustration of a diagram of example tokenization architectures;

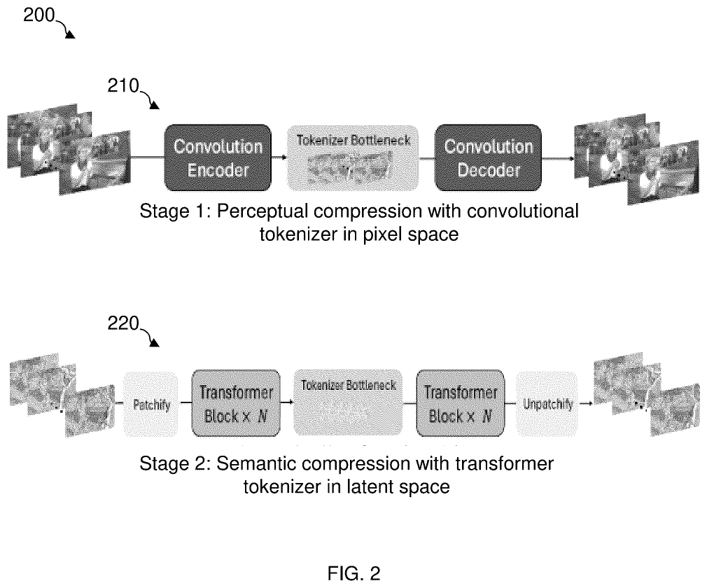

FIG. 2 is an illustration of a flow diagram of example tokenizer frameworks;

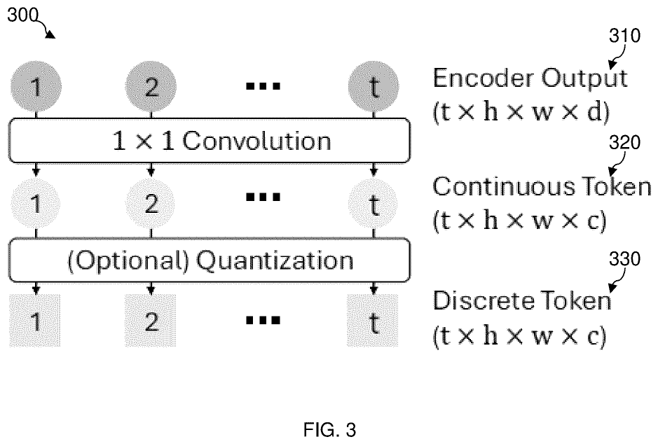

FIG. 3 is an illustration of a diagram of example tokenizer bottlenecks;

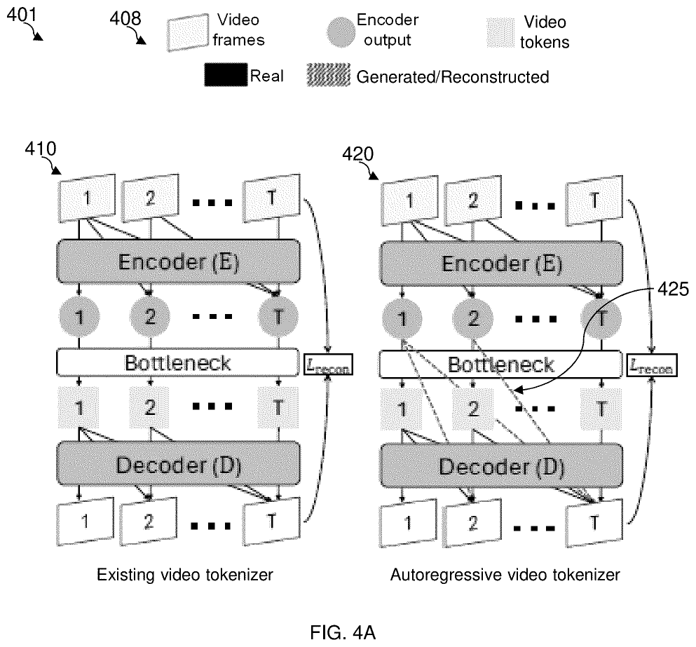

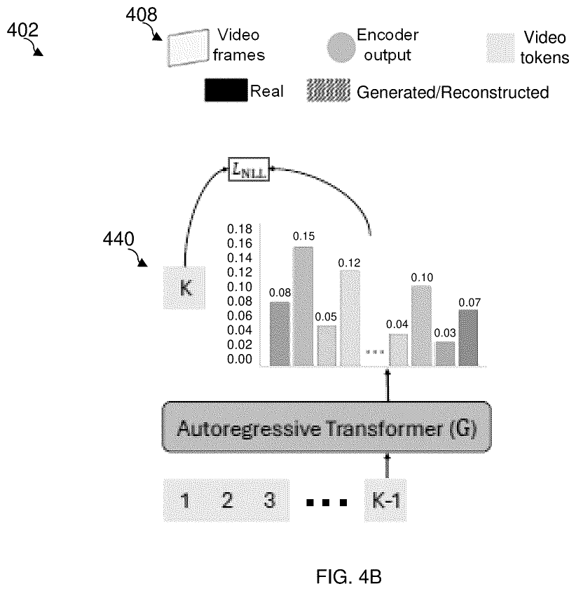

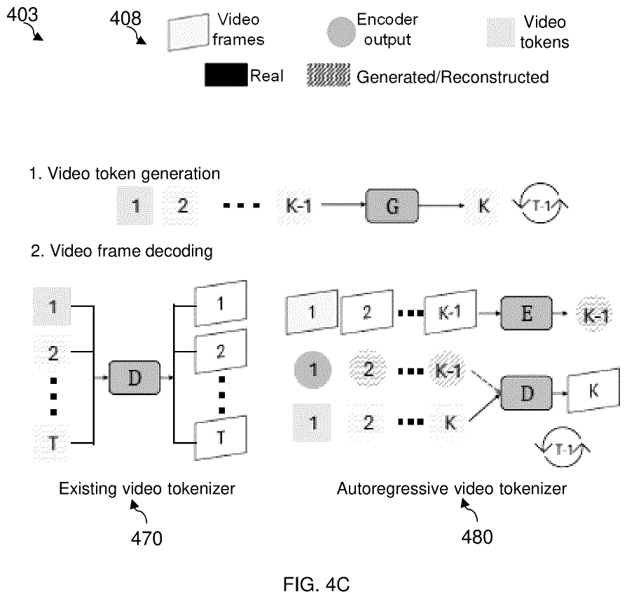

FIG. 4A is an illustration of a diagram of an example video tokenizer training;

FIG. 4B is an illustration of a diagram of an example video generation model training;

FIG. 4C is an illustration of a diagram of an example video prediction inference;

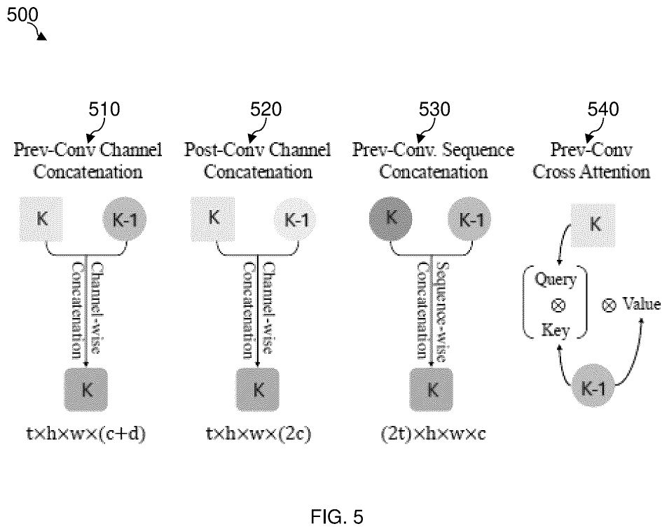

FIG. 5 is an illustration of a diagram of an example autoregressive tokenizer design;

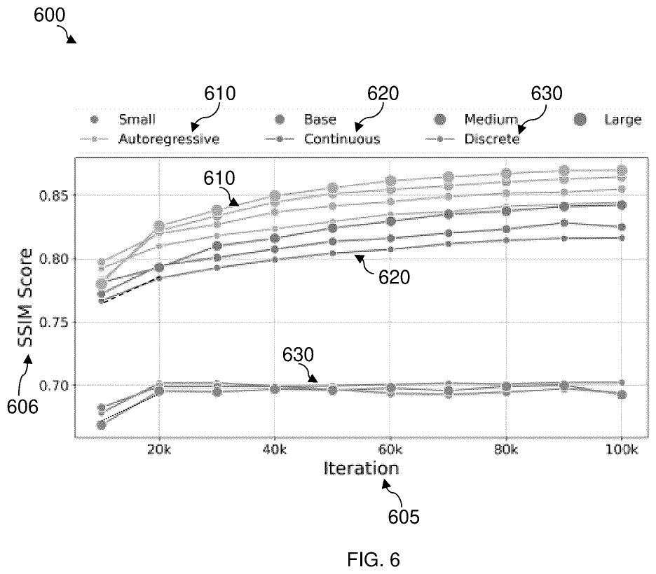

FIG. 6 is an illustration of a diagram of an example chart demonstrating the SSIM scores collected during experimentation using different sized data models;

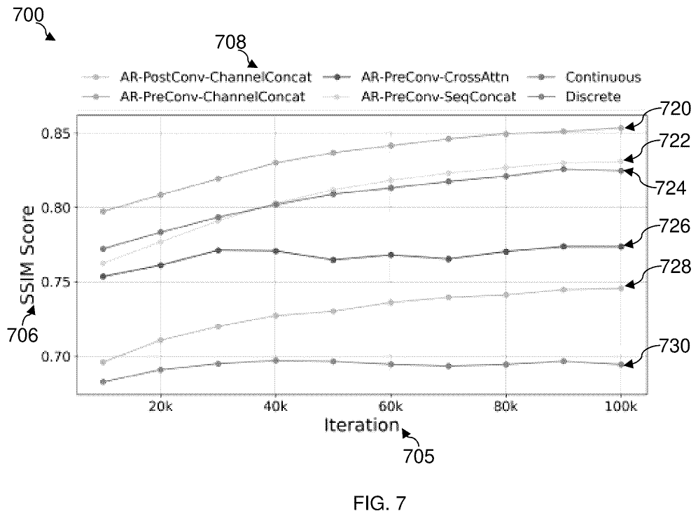

FIG. 7 is an illustration of a diagram of an example chart demonstrating the effectiveness of different approaches to utilize autoregressive information;

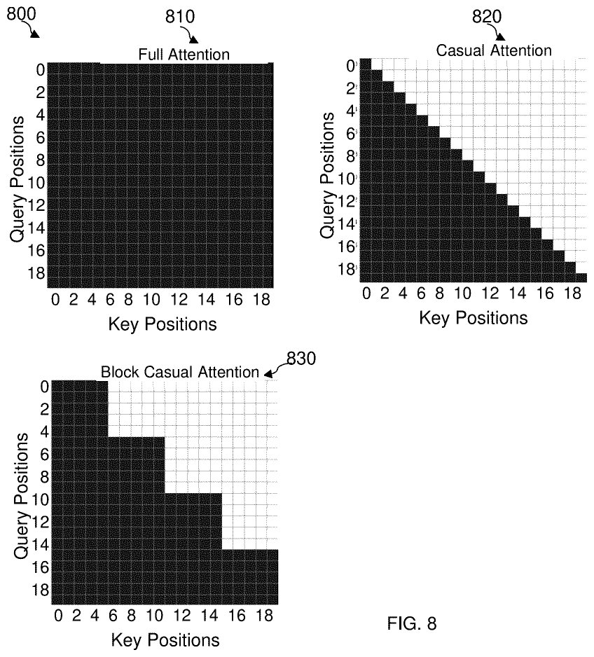

FIG. 8 is an illustration of a diagram of example charts showing attention patterns that can be utilized;

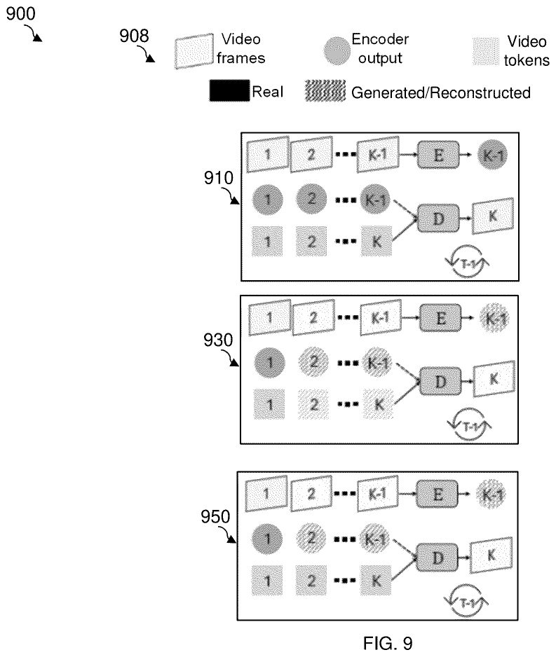

FIG. 9 is an illustration of a diagram of example autoregressive tokenizer decoding models;

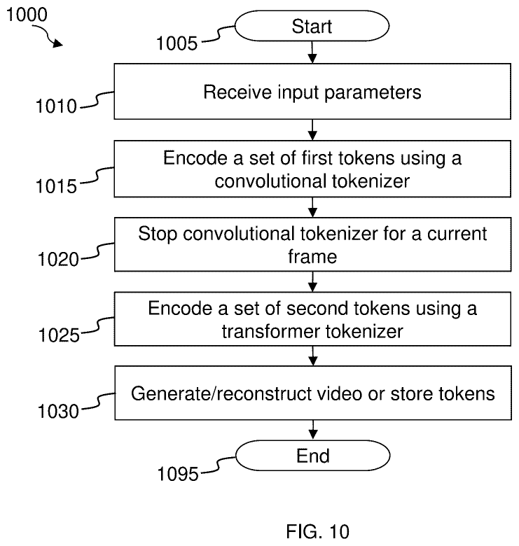

FIG. 10 is an illustration of a flow diagram of an example method 1000 for an autoregressive tokenizer for implementing the disclosed tokenization framework processes;

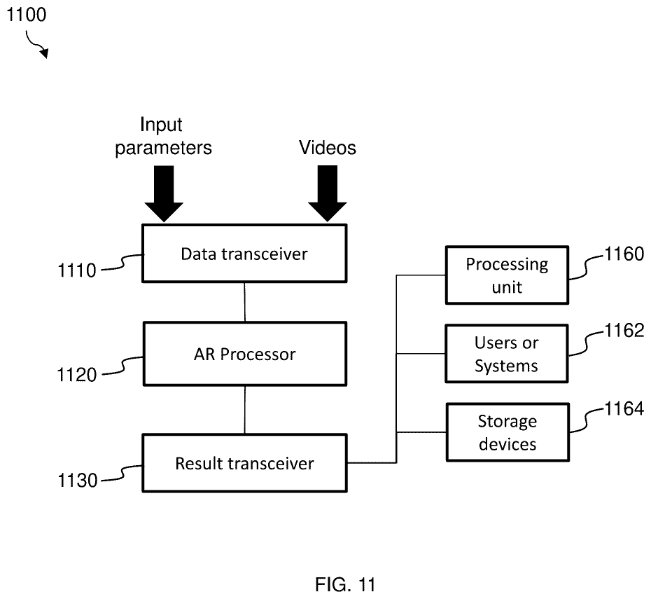

FIG. 11 is an illustration of a block diagram of an example AR system; and

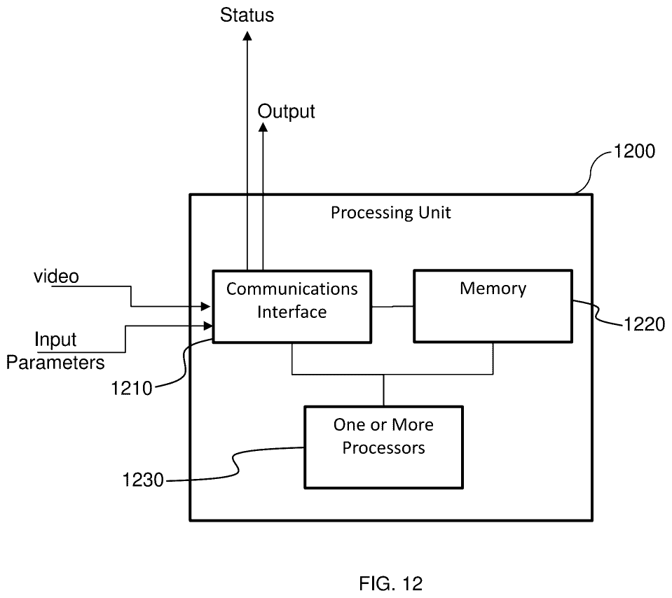

FIG. 12 is an illustration of a block diagram of an example of an AR controller according to the principles of the disclosure.

### DETAILED DESCRIPTION

The rise of large-scale generative models like generative pretrained transformers (GPTs) has propelled artificial intelligence (AI) forward. Video, like language, is another modality with abundant data across the web, and offers orthogonal knowledge about our physical world and motion dynamics. Training large-scale video generative models has thus sparked broad interest. Unlike language, the information contained in videos can be sparse, implicit, and highly redundant. As a result, video model training is typically behind the scale of large language models (LLMs) training.

One approach to scaling video generative models can be to develop compact video representations. The common approach adopted in modern vision-language models (VLMs) and video generation models can be to train on discrete or continuous tokens produced by a video compression model, also called a video tokenizer system. The state-of-the-art video models tend to adopt tokenizers with a convolution type architecture due to their efficiency on high-resolution videos. Transformer models can be used as well, as they have grown in popularity for various visual recognition and generation tasks due to their scalability.

A property of video data can be its causal nature, meaning that the current frame depends on the past frames, not future frames. While some existing approaches incorporate causal structure in their architectures, their primary goal can be to enable joint training on images and videos. This property of video data can be leveraged in video generation, where frames are generated sequentially through methods such as autoregressive (AR) transformers or sliding-window diffusion models. This indicates that the past frames are already generated when decoding the current frame.

An autoregressive model can use previously encoded frames to decode the current frames, which can improve the tokenization efficiency. By implementing the tokenizer based on a transformer architecture in the latent space of a convolutional tokenizer, a video tokenizer model can be scaled with more data and larger models. Consequently, this model can achieve a higher compression ratio while minimizing compromising of the reconstruction quality.

This disclosure presents processes to train transformer tokenizers in the latent space of a pre-trained convolution tokenizer, enabling high-resolution video tokenization and allowing efficient design ablation (where high-resolution means 1080-pixel resolution or higher). The disclosed processes can be implemented using an autoregressive video tokenizer (e.g., an autoregressive tokenization process) that can leverage expressive features from previous frames in the tokenizer encoder to enhance the decoding of the current frame. Expressive features are features from a previous frame that are used to decode the current frame.

This approach circumvents the information bottleneck imposed by the tokenizer latent space, e.g., quantization in discrete tokenizers and small channel dimension in continuous tokenizers. In inference time, the encoder and decoder can operate recursively to produce the video in an autoregressive manner, as the encoder features are integrated into the decoding process.

The processes can train transformer-based discrete and continuous tokenizers with varying designs and model sizes. When training continuous tokenizers (tokenizers that produce continuous-valued tokens), the transformer-based tokenizers can improve reconstruction quality as the model size and dataset are scaled up. In the case of discrete tokenizers, due to the presence of a quantization layer, scaling gains are smaller than those using the continuous tokenizer models. The autoregressive tokenizer can show consistent performance gains with scaling of the model size and dataset size. A content-motion decomposition can emerge with the autoregressive design, where the tokens representing the current frame encode the difference from a defined number of previous frames, such as one, two, five, or other number of previous frames, for example, three previous frames.

Through experimentation, the autoregressive tokenizer can achieve competitive reconstruction quality compared with the other state-of-the-art tokenizers while achieving higher compression rates than the other state-of-the-art tokenizers, such as 8× better compression or other compression ratios. To further demonstrate the strength of the disclosed processes, implementing a scalable tokenizer design, video prediction models with different video tokenizers can be trained. Given equivalent computational resources, the quality improvements in tokenizer reconstruction using the disclosed processes can translate to improved generation quality as compared to other state-of-the-art processes.

Training latent generative models can involve a two-stage approach (1) training the tokenizer, and (2) training the generative model on the tokens produced by the frozen tokenizer. During inference, the model first generates tokens and decodes them into the pixel space using the tokenizer decoder. The tokenizer's reconstruction quality can determine the ceiling of the generation quality, and the compression rate can determine the context length and, thus, the training cost of the generative models. There can be tokenizer bottlenecks, such as shown in FIG. 3, for example, the small channel dimension in the continuous tokenizer or the quantizer in the discrete tokenizer.

Some existing video tokenizers stay with a compression rate of 4× in temporal and 8× in spatial dimensions. Increasing the compression rate for the existing video tokenizers can lead to reconstruction quality degradation, while increasing the number of parameters does not relieve the issue. The inductive bias of convolution layers can severely limit the achievable compression rate.

The most prominent visual elements, like the edges, can be clearly identified in the latent. This demonstrates that primarily perceptual information can be compressed, while redundancy remains in the tokens. The disclosed processes can overcome these issues by using transformers, which do not have the local inductive bias, to perform semantic compression. Due to the high dimensionality of input videos, the quadratic complexity of attention induces a prohibitively expensive computational cost to train a transformer tokenizer. To put this in perspective, on an 80 GB A 100 GPU, using a transformer block with a channel size of 512, a maximum of a 30-frame 32×32 resolution video clip can be processed. One straightforward way to improve efficiency is to use patchify layers with a large patch size of 16 ×16 ×16. Although this is a common choice in visual pre-training methods, it is challenging to improve reconstruction with large sizes of unpatchify layers.

There is a resemblance between the pixel space and the latent space, which indicates that a two-stage model that trains a transformer tokenizer in the latent space of a pre-trained convolutional tokenizer can improve the efficiency of the process. As shown in FIG. 2, in a stage 1, a continuous convolutional tokenizer can be trained to first encode the video for perceptual compression. In a stage 2, the convolutional tokenizer can be frozen (e.g., stopping further processing after the last frame of the video has been tokenized), and a transformer tokenizer can then be trained on the encoded video latent for semantic compression. As the input can have a smaller size, the transformer tokenizer can be trained more efficiently. Although the convolutional tokenizers define the upper bound of the reconstruction quality, the transformer tokenizer can approach this upper bound with a higher compression rate as compared to other state-of-the-art processes, even with the quantizer bottleneck.

To facilitate reducing the temporal redundancy, the video's autoregressive property in the tokenizer design can be used. The existing video generation models often perform inference in an autoregressive manner. That is, the previous frames are already generated when decoding the generated tokens of the current frames. With this insight, the features from previous frames can be utilized to help decode the current frame. These features can come from continuous latents before the tokenizer bottleneck is encountered in the processing of the video, providing more informative features about the previous frames, rather than gathering the features after encountering the small channel dimension or quantized bottlenecks in the processing of the video. By gathering the features at an earlier stage, the reconstruction quality can be improved over existing solutions. This design can apply to a convolutional architecture as well as the transformer architecture.

The causal structure can be adopted in video tokenizers to block the information flow from future frames to the current frame. The major application can be to enable joint training on the diverse image dataset. In the transformer tokenizer architecture, the causal structure can be inherited by implementing block causal attention. The pre-bottleneck features from previous frames can be used when decoding the current frames. There can be various methods for implementing the disclosed processes.

In some aspects, these methods can be combined in various combinations, thereby increasing the variety and opportunity to improve the optimization of the processes. (1) Prev-Convolution Concatenation—the process can concatenate the previous frame's features before the convolution bottleneck with the current frame's tokens in the channel dimension. (2) Post-Convolution Concatenation—the process can concatenate the previous frame's features after the convolution bottleneck with the current frame's tokens in the channel dimension. (3) Sequence Concatenation—the process can concatenate the previous frame's features before the convolution bottleneck with the current frame's tokens in the sequence dimension. (4) Cross-Attention—the process can add a cross-attention layer after each attention layer in the decoder to allow the current frame to attend selectively to previous frames'continuous features. In some aspects, continuous features can be latent vectors that capture visual appearance and motion information of a token.

After training the tokenizer, the tokenizer can be frozen (e.g., stopping the video transformer tokenizer from further processing, for example, after the last frame of the video has been tokenized) and then can be used to train a generative model on video tokens encoded by it. In some aspects, the generative model training can be identical for the autoregressive and vanilla tokenizers when performing video prediction. Autoregressive tokenizer decoding can use the continuous features of the first frame, which can be obtained with either a text-to-image model or training the video generative model to predict the features.

During the inference time, the types of models can first generate tokens using the latent generative models. Rather than decoding the tokens simultaneously, the autoregressive tokenizer can decode the tokens in an autoregressive way. At each step, the previously generated frames can be encoded to produce the pre-bottleneck continuous features used to decode the current frame. This step can be repeated until the video decoding is completed. The decoding process does not need to wait until the token generation is completed. In some aspects, the autoregressive decoding can be parallelized with autoregressive generation to improve the efficiency.

Continuous and autoregressive tokenizers can be improved with more parameters, while discrete tokenizers do not generally improve. In experimentation, three different sizes (S, B, M) of continuous and discrete transformer tokenizers can be trained and then compared with the disclosed autoregressive tokenizer trained using Pre-Conv concatenation. Forty-nine frame clips can be sampled from each video while computing their average SSIM score. In the experimentation, the discrete tokenizer does not demonstrate significant improvement as compared to the other models tested, with a larger transformer model or longer training, with the three different model sizes achieving similar reconstruction quality. The continuous and autoregressive tokenizers improve substantially with larger model sizes and longer training. In some aspects, the bottleneck imposed by the discrete quantizer can limit the achievable reconstruction quality. The autoregressive tokenizer can work better than the continuous tokenizers across different model sizes, as compared to existing solutions.

There can be several ways to combine the information from previous frames with the current encoder output. To compare these different choices, the transformer tokenizers can be trained with each method using the tokenizer model with the Base model size. The input channel size of the 1×1 convolution can be adjusted at the beginning of the decoder to accommodate the change when using channel concatenation. Sequence concatenation can result in more computations by doubling the context length of the decoder. The total number of layers can be reduced accordingly to keep the model size relatively the same when using cross-attention. When leveraging the features from previous frames, the reconstruction quality can be improved over the discrete tokenizer and other existing solutions. The features before the convolution bottleneck can be more informative than the features after the convolution bottleneck, enabling autoregressive tokenizers to outperform continuous tokenizers, e.g., the previous convolution concatenation method demonstrates the best improvement as compared to the other methods. The channel concatenation works best among different approaches to mixing the features.

The training-inference gap can be a concern for latent generative models. Specifically, the tokens generated by the latent generative model may not be seen by the tokenizer during the training and cause an out-of-distribution effect. This could be even more concerning for autoregressive tokenizers since, apart from the unseen tokens, the autoregressive tokenizer can face other gaps. The continuous features during the inference can be encoded from the generated frames instead of the real frames. In some aspects, to address this concern, the continuous features from the first frame and the discrete tokens are provided, and the decoder autoregressively decodes the video. This aspect can outperform the baselines while addressing the bias.

The disclosed process design can enforce motion-content decomposition. The discrete tokens can encode the motion of previous features and the new content. For example, autoregressive reconstruction can be performed with continuous features set to zero. Unseen objects can be encoded as discrete tokens. This aspect can induce the tokenizer's zero-shot capability in video editing. For a given video, the first frame can be edited with image translation models. Then, the video can be reconstructed with the edited continuous features and original discrete tokens, generating a reconstructed video. This can allow the edited style to propagate throughout the video.

Turning now to the figures, FIG. 1 is an illustration of a diagram of example tokenization architectures 100. Tokenization architectures 100 shows a Flux model 110 and a Cosmos model 120. Flux model 110 is a demonstration of an image using a text-to-image model. Cosmos model 120 is a demonstration of a video using a continuous tokenizer. The latent tokens can be visualized by normalizing the first three channels of the red-green-blue (RGB) channels, as shown in the bottom left of each frame. The tokens resemble the input regarding the overall structure, presenting a type of redundancy that can be taken advantage of in the disclosed processes. The static regions in the video frames over time show temporal redundancy as well, which can be further pruned.

The latent space of image and video tokenizers closely resembles the original pixel space by preserving most of the visual structure. The most prominent visual elements, like the edges, can be clearly identified in the latent. This demonstrates that perceptual information is compressed, while a significant amount of redundancy can be preserved in the tokens. For example, the table in the background of Cosmos model 120 remains static and uses nearly identical tokens over time.

FIG. 2 is an illustration of a flow diagram of example tokenizer frameworks 200. Tokenizer frameworks 200 demonstrate a convolutional architecture 210 that employs a convolution-based architecture to perform perceptual compression. A transformer architecture 220 shows the training of a transformer tokenizer in the latent space of a pre-trained convolutional tokenizer for semantic compression.

In stage 1, e.g., convolutional architecture 210, the continuous convolutional tokenizer can be trained to encode the video for perceptual compression, thereby generating a trained continuous convolutional encoder. In stage 2, e.g., transformer architecture 220, the convolution tokenizer can be frozen, and a transformer tokenizer can be trained on the encoded video latent for semantic compression.

FIG. 3 is an illustration of a diagram of example tokenizer bottlenecks 300. Tokenizer bottlenecks 300 demonstrate two common types of bottlenecks that can occur in tokenizers. A 1×1 convolution layer maps a large encoder channel dimension 310 into a small latent channel dimension 320, for example, mapping a dimension of 512 to a dimension of 6, where other dimensions can be used for the mapping. In some aspects, an optional quantizer 330 can be used in discrete tokenizers to quantize the tokens.

FIG. 4A is an illustration of a diagram of an example video tokenizer training 401. Video tokenizer training 401 has an object key 408 showing the different components or stages of the training process. An existing video tokenizer 410 demonstrates what is occurring using conventional solutions. An autoregressive video tokenizer 420 demonstrates that the continuous features from previous frames can be used to decode the current frame, as shown by the dashed lines 425.

FIG. 4B is an illustration of a diagram of an example video generation model training 402. Video generation model training 402 uses the object key 408 as in FIG. 4A. Video generation model training 402 shows model 440, which can be similar to the training for existing tokenizers. Model 440 further demonstrates an autoregressive transformer trained for next-token prediction.

FIG. 4C is an illustration of a diagram of an example video prediction inference 403. Video prediction inference 403 uses the object key 408 as in FIG. 4A. Video prediction inference 403 has a frame decoding 470 showing the typical decoding of existing video tokenizers, and a frame decoding 480 showing the autoregressive decoding. During inference time, frame decoding 480 can re-encode one or more of the previously generated frames when decoding the current frame.

FIG. 5 is an illustration of a diagram of an example autoregressive tokenizer design 500. Autoregressive tokenizer design 500 demonstrates four possible designs that can be implemented. Different pre-bottleneck features can be used to combine the expressive features with the original encoder output. In some aspects, these designs can be combined in various combinations to improve efficiency and optimization. Shown is a previous convolutional channel concatenation 510, a post convolutional channel concatenation 520, a previous convolutional channel sequence concatenation 530, and a previous convolutional cross-attention algorithm 540.

FIG. 6 is an illustration of a diagram of an example chart 600 demonstrating the SSIM scores collected during experimentation using different sized data models. Chart 600 shows the output after training discrete tokenizers, continuous tokenizers, and autoregressive tokenizers. The SSIM score was computed using a subset of the TokenBench system across different training iterations. The continuous and autoregressive tokenizers tend to improve with larger model sizes and longer training, while the discrete tokenizers do not. The autoregressive tokenizer using the disclosed processes resulted in better performance than the conventional solutions.

Chart 600 has a key 608 showing the model sizes as increasingly larger circles. An x-axis 605 shows the number of iterations, and a y-axis 606 shows the SSIM score from TokenBench. The autoregressive iterations are shown using the solid lines 610, the continuous iterations are shown using dashed lines 620, and the discrete iterations are shown using dotted lines 630.

FIG. 7 is an illustration of a diagram of an example chart 700 demonstrating the effectiveness of different approaches to utilize autoregressive information. Chart 700 demonstrates a quantitative comparison of the various approaches to combine the features from previous frames with the current frame's encoder output.

Chart 700 has an x-axis 705 showing the number of iterations run and a y-axis 706 showing the SSIM score as reported by TokenBench. A key 708 shows the different plot lines as described further herein. The plot of chart 700 shows the relative advantage of each type of approach to using the autoregressive information. A line 720 represents the results when using an autoregressive previous convolutional channel concatenation. A line 722 represents the results when using an autoregressive previous convolutional sequential concatenation. A line 724 represents the results when using a continuous tokenization model. A line 726 represents the results when using an autoregressive previous convolutional cross-attention model. A line 728 represents the results when using an autoregressive post convolutional channel concatenation. A line 730 represents the results when using a discrete tokenization model. Overall, line 720 appears to provide the highest optimization and efficiency as compared to the other method types.

FIG. 8 is an illustration of a diagram of example charts 800 showing attention patterns that can be utilized. The block causal attention model, e.g., a type of autoregressive previous convolutional cross-attention model, can be used with the disclosed processes by the autoregressive tokenizer. A block 810 shows a full attention model. A block 820 shows a causal attention model. A block 830 shows a block causal attention model. Dark blocks indicate “unmasked,” and bridge blocks indicate “masked”.

In some aspects, a design in the autoregressive tokenizer can utilize the causal structure, which blocks the current frame from using the information of later frames. This allows the frames to be encoded and decoded in a streaming way. For example, during inference time, the frame can be decoded once the latent generative models generate its tokens and the tokens of at least the immediately previous frame(s). For convolution tokenizers, this can be implemented with causal convolution and asymmetric paddings. For existing transformer tokenizers, this can be implemented through separate patchify layers for images and videos, and causal attention layers.

In some aspects, the disclosed processes can achieve causality by using block causal attention. Since the causality of videos occurs among frames, the major difference between block causal attention and causal attention is that block causal attention can allow attention among different tokens spatially within the same frame. Instead of using different patchify layers to handle images and videos, the first frame can be repeated when the number of frames is not divisible by the temporal patch size.

FIG. 9 is an illustration of a diagram of example autoregressive tokenizer decoding models 900. Autoregressive tokenizer decoding models 900 has a key 908. A video reconstruction model 910 demonstrates that when performing video reconstruction, the features and tokens can be obtained from real video frames to reconstruct the videos, consistent with how the tokenizers are trained. A video prediction inference 930 demonstrates that when using an autoregressive tokenizer in video prediction, the encoder features and the video tokens can be generated. The video tokens can be generated by the latent generative model, and the encoder features are obtained from encoding the generated frames. An autoregressive reconstruction model 950 demonstrates that to narrow the training-inference gap, the tokenizers can be evaluated using the encoder features from the reconstructed frames or reconstructed video.

Video reconstruction model 910 and video prediction inference 930 show that there are various types of training gaps between autoregressive training and inference. First, the video tokens during the inference can be generated by the latent generative model instead of being produced by real frames. Second, the encoder features can be extracted from the generated frames instead of the real frames. To mimic the inference scenario, the disclosed processes can use the encoder features from the reconstructed frames (or reconstructed video) instead of the real frames to reconstruct the current frame. Using continuous features from reconstructed frames can induce more errors in the reconstruction and can lead to a lowering of the quality when compared to conventional reconstruction. Autoregressive tokenizers can outperform the baseline on various metrics and dataset sizes. The training inference gap left can be the video tokens, which exist in autoregressive tokenizers and existing tokenizers. In some aspects, increasing the model size of the autoregressive tokenizer can improve the reconstruction quality.

FIG. 10 is an illustration of a flow diagram of an example method 1000 for an autoregressive tokenizer for implementing the disclosed tokenization framework processes. Method 1000 can be performed on a computing system, for example, autoregressive (AR) system 1100 of FIG. 11 or AR controller 1200 of FIG. 12. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 1000 can be encapsulated in software code or hardware, for example, an application, code library, code module, dynamic link library, module, function, RAM, ROM module, and other software and hardware implementations. The software can be stored in a file, database, or other computing system storage mechanism. Method 1000 can be partially implemented in software and partially in hardware. Method 1000 can perform the steps for the described processes, for example, training an autoregressive tokenization model or reconstructing videos.

Method 1000 starts at a step 1005 and proceeds to a step 1010. In step 1010, input parameters can be received. The input parameters can include a video to be tokenized. The input parameters can include one or more algorithms to use. For example, the system can use one of various types of encoders and decoders and processes, such as using a previous convolution concatenation process, a post convolution concatenation process, a sequence concatenation process, a cross-attention concatenation process, or combinations thereof. The input parameters can include thresholds used to adjust the operational parameters of the tokenizer framework processes.

In a step 1015, a first set of tokens can be generated using the frames of the video using a convolutional tokenizer in a pixel space. The first set of tokens can correspond to a perceptual compression of the frames of the video. In a step 1020, the processing of the convolutional tokenizer can be frozen, e.g., stopped, from further processing, such as after the last frame of the video has been tokenized.

In a step 1025, a second set of tokens can be generated from the first set of tokens using a video transformer tokenizer in a latent space. The second set of tokens can correspond to a semantic compression of the frames of the video. The second set of tokens can represent an encoding of the frames of the video into video tokens.

In step 1030, the second set of tokens can be used in various ways. For example, the tokens can be used to train a video machine learning model using a machine learning system (e.g., update the machine learning model). The tokens can be used to reconstruct a video, such as using the tokenization process as a compression process. The tokens can be used to generate a new video, such as training a video generation system on previous videos and then using the trained tokenization model to generate new videos based on provided prompts, such as text prompts. The tokens can be stored in a data store, such as a video library, database, or other computer storage system for use at a later time. Method 1000 ends at a step 1095.

FIG. 11 is an illustration of a block diagram of an example AR system 1100. AR system 1100 can be implemented in one or more computing systems or one or more processors. In some aspects, AR system 1100 can be implemented using a tokenizer controller such as AR controller 1200 of FIG. 12. AR system 1100 can implement one or more aspects of this disclosure, such as method 1000 of FIG. 10.

AR system 1100, or a portion thereof, can be implemented as an application, a code library, a dynamic link library, a function, a module, a header file, other software implementations, or combinations thereof. In some aspects, AR system 1100 can be implemented in hardware, such as a ROM, a graphics processing unit, or other hardware implementations. In some aspects, AR system 1100 can be implemented partially as a software application and partially as a hardware implementation. AR system 1100 is a functional view of the disclosed processes, and an implementation can combine or separate the functions in one or more software or hardware systems.

AR system 1100 includes a data transceiver 1110, an AR processor 1120, and a result transceiver 1130. The output, which can comprise one or more of the reconstructed or generated videos represented by tokens generated by the tokenization framework (e.g., one or more output frames), or interim outputs, can be communicated to a data receiver as a result, such as to one or more of processing systems 1160 (one or more combinations of processors, or processing cores), one or more users or systems 1162, or one or more storage devices 1164.

In some aspects, the results of AR processor 1120, such as those communicated to one or more processing systems 1160, one or more storage devices 1164, or one or more users or systems 1162, can be used as input into another process or system, such as a machine learning system. The results can be used for further processing, such as for input into artificial intelligence learning, for validation of other system processes, or real-world applications.

Data transceiver 1110 can receive the input parameters. The input parameters can include algorithms to use, various threshold parameters, and other operation parameters. In some aspects, data transceiver 1110 can be part of AR processor 1120.

Result transceiver 1130 (e.g., a transmitter) can communicate one or more outputs (e.g., results), to one or more data receivers, such as processing systems 1160, one or more users or systems 1162, storage devices 1164, or other related systems, whether proximate result transceiver 1130 or distant from result transceiver 1130. Data transceiver 1110, AR processor 1120, and result transceiver 1130 can be, or can include, conventional interfaces configured for transmitting and receiving data. Data transceiver 1110, AR processor 1120, or result transceiver 1130 can be implemented as software components, for example, a virtual processor environment, as hardware, for example, circuits of an integrated circuit, or combinations of software and hardware components and functionality. The functionality described for these components remains intact regardless of how the functionality is implemented.

AR processor 1120 (e.g., one or more processors such as processor 1230 of FIG. 12) can implement the analysis and algorithms as described herein, utilizing the input parameters. AR processor 1120 can execute code to implement an AR tokenization framework to tokenize input videos and generate or reconstruct videos. In some aspects, AR processor 1120 can implement a video tokenizer system to perform the video tokenization processes described herein. In some aspects, AR processor 1120 can implement an autoregressive tokenization process described herein. In some aspects, the autoregressive tokenization process can be implemented by AR processor 1120 or by a video transformer tokenizer. In some aspects, AR processor 1120 can be the video transformer tokenizer.

In some aspects, AR processor 1120 can implement a convolutional encoder configured to generate a first set of video tokens from a training video, wherein the convolutional encoder utilizes a convolutional tokenizer in a pixel space corresponding to a perceptual compression of frames of the training video. In some aspects, AR processor 1120 can implement a transformer encoder configured to utilize a video transformer tokenizer in a latent space corresponding to a semantic compression of the frames of the training video, and the transformer encoder utilizes the first set of video tokens as input to generate a second set of video tokens. In some aspects, AR processor 1120 can implement an autoregressive convolutional decoder configured to generate output frames utilizing the second set of video tokens.

AR processor 1120 can be one or more of a multicore processor, a multiprocessor system, or a streaming multiprocessor. AR processor 1120 can be implemented by a central processor unit (CPU), a graphics processor unit (GPU), or other types of processors. AR processor 1120 can be a non-transitory computer program product having a series of operating instructions stored on a non-transitory computer-readable medium that directs a tokenization processing apparatus, when executed thereby to perform operations as disclosed herein.

A memory or data storage system of AR processor 1120 (such as a core cache, L1 cache, L2 cache, or other memory systems) can be configured to store the processes and algorithms for directing the operation of AR processor 1120. AR processor 1120 can include a processor that can be configured to operate according to the analysis operations and algorithms disclosed herein, and an interface to communicate (transmit and receive) data.

FIG. 12 is an illustration of a block diagram of an example of an AR controller 1200 according to the principles of the disclosure. AR controller 1200 can be stored on one computer or multiple computers. The various components of AR controller 1200 can communicate via wireless or wired conventional connections. A portion or a whole of AR controller 1200 can be located at one or more locations. In some aspects, AR controller 1200 can be part of another system (e.g., processor, core, server, or other systems), and can be integrated with one device, such as a part of a processing system. AR controller 1200 represents a demonstration of the functionality employed for the disclosure, and implementations can use a variety of devices, for example, circuits of a processor, dedicated processors, virtual systems, servers, other computing or processing systems, in software or hardware, or various combinations thereof.

AR controller 1200 can be configured to perform the various functions disclosed herein, including receiving input parameters, and generating results from the execution of the methods and processes described herein, such as determining tokens for a video, reconstructing or generating a video represented by the tokens, and generating a resulting video. AR controller 1200 includes a communications interface 1210, a memory 1220, and a processor 1230.

Communications interface 1210 can be configured to transmit and receive data. For example, communications interface 1210 can receive the input parameters. Communications interface 1210 can transmit the output or interim outputs. In some aspects, communications interface 1210 can transmit a status, such as a success or failure indicator of AR controller 1200 regarding receiving the various inputs, transmitting the generated outputs, or producing the results.

In some aspects, processor 1230 can perform the operations as described by AR processor 1120. Communications interface 1210 can communicate via the communication systems used in the industry. For example, wireless or wired protocols can be used. Communications interface 1210 can perform the operations as described for data transceiver 1110 and result transceiver 1130 of FIG. 11.

Memory 1220 can be configured to store a series of operating instructions that direct the operation of processor 1230 when initiated, including supporting code representing the algorithm for performing a tokenization of an input video. Memory 1220 can be a non-transitory computer-readable medium. Multiple types of memory can be used for the data storage systems, and memory 1220 can be distributed.

Processor 1230 can be one or more processors. Processor 1230 can be a combination of processor types, such as a CPU, a GPU, a single instruction multiple data (SIMD) processor, or other processor types. Processor 1230 can be configured to produce the output, one or more interim outputs, and statuses utilizing the received inputs. In some aspects, processor 1230 can implement a video tokenizer system to perform the video tokenization processes described herein. In some aspects, processor 1230 can implement an autoregressive tokenization process described herein. In some aspects, the autoregressive tokenization process can be implemented by a video transformer tokenizer. In some aspects, the video transformer tokenizer and be processor 1230.

Processor 1230 can determine the output using parallel processing. Processor 1230 can be an integrated circuit. In some aspects, processor 1230, communications interface 1210, memory 1220, or various combinations thereof, can be an integrated circuit. Processor 1230 can be configured to direct the operation of AR controller 1200. Processor 1230 includes the logic to communicate with communications interface 1210 and memory 1220, and performs the functions described herein. Processor 1230 can be capable of performing or directing the operations as described by AR processor 1120 of FIG. 11.

For example, in some aspects, AR system 1100 or AR controller 1200 can determine a tokenization process for a video, compress the video represented by the tokens, and generate a video from the tokens.

In some aspects, AR system 1100 or AR controller 1200 can be part of another system that receives the input parameters. For example, in some aspects, AR system 1100 or AR controller 1200 can be part of a machine learning system, an AI generative tool, or can be in a data center, a cloud system, an edge system, a corporate system, or another type of system or location. In some aspects, AR system 1100 or AR controller 1200 can be part of a machine learning system, where AR processor 1120 can support the implementation of the machine learning model. In some aspects, AR system 1100 or AR controller 1200 can implement a non-transitory computer program product having a series of operating instructions stored on a non-transitory computer-readable medium that directs a data processing apparatus, when executed thereby to perform operations, the operations comprising the steps described herein for this disclosure, such as method 1000 of FIG. 10.

A portion of the above-described apparatus, systems, or methods can be embodied in or performed by various digital data processors or computers, wherein the computers are programmed or store executable programs of sequences of software instructions to perform one or more of the steps of the methods. The software instructions of such programs can represent algorithms and be encoded in machine-executable form on non-transitory digital data storage media, e.g., magnetic or optical disks, random-access memory (RAM), magnetic hard disks, flash memories, or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs can be included on a graphics card that includes one or more memory devices and is configured to interface with the motherboard of a computer. The GPUs can be integrated GPUs (iGPUs) that are co-located with a CPU on one chip. Configured or configured to means, for example, designed, constructed, or programmed, with the logic or features for performing a task or tasks. The processors or computers can be part of GPU racks located in a data center. The GPU racks can be high-density (HD) GPU racks that include high-performance GPU compute nodes and storage nodes. The high-performance GPU compute nodes can be servers designed for general-purpose computing on graphics processing units (GPGPU) to accelerate deep learning applications. For example, the GPU compute nodes can be servers of the DGX product line from NVIDIA Corporation of Santa Clara, California.

The compute density provided by the HD GPU racks is advantageous for AI computing and GPU data centers directed to AI computing. The HD GPU racks can be used with reactive machines, autonomous machines, self-aware machines, and self-learning machines can have a large compute-intensive server infrastructure. For example, the GPU data centers employing HD GPU racks can provide the storage and networking needed to support large-scale neural network (NN) training, such as for the NNs disclosed herein used for neural motion planners. The NNs can be Deep Neural Networks (DNN).

The NNs disclosed herein include multiple layers of connected nodes that can be trained with input data to solve complex problems. For example, contextual data, UPC, proposed trajectories, or a combination thereof can be used as input data for training of the NN. Once the NNs are trained, the NNs can be deployed and used to generate planned trajectories.

In one example of training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as those noted above are capable of delivering the performance for training NNs for artificial intelligence and machine learning applications.

Portions of disclosed examples or embodiments can relate to computer storage products with a non-transitory computer-readable medium that have program code thereon for performing various computer-implemented operations that embody a part of an apparatus, device, or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the logic or features for performing a task or tasks. Examples of program code include machine code, such as produced by a compiler, and files containing higher-level code that can be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, utilized, or combined with other elements, components, or steps that are not expressly referenced.

Those skilled in the art to which this application relates will appreciate that other and further additions, deletions, substitutions, and modifications can be made to the described embodiments. It is also to be understood that the terminology used herein is to describe particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein. Additional material is also submitted herewith.

Various aspects of the disclosure can be claimed including the apparatuses, systems, and methods as noted in the Summary. Each of the noted aspects can have one or more of the additional features of the below dependent claims in combination.

What is claimed is:

1. A method, comprising:
generating a set of first tokens of frames of a video using a convolutional tokenizer in a pixel space, wherein the set of first tokens corresponds to a perceptual compression of the frames of the video;
freezing the convolutional tokenizer from further processing; and
generating a set of second tokens from the set of first tokens using a video transformer tokenizer in a latent space, wherein the set of second tokens corresponds to a semantic compression of the frames of the video, and the set of second tokens is an encoding of the frames of the video into video tokens.

2. The method as recited in claim 1, wherein the set of second tokens is used to train a video tokenizer system.

3. The method as recited in claim 1, wherein the video transformer tokenizer is an autoregressive tokenization process.

4. The method as recited in claim 1, further comprising:
decoding the set of second tokens into one or more output frames of a reconstructed video.

5. The method as recited in claim 4, wherein the decoding uses continuous features from one or more of the frames to decode a current one of the one or more output frames.

6. The method as recited in claim 5, wherein the continuous features from one or more of the frames are restricted to a maximum of three previous frames from the current one of the one or more output frames.

7. The method as recited in claim 1, wherein the convolutional tokenizer is a trained continuous convolutional encoder.

8. The method as recited in claim 1, wherein the generating the set of second tokens further utilizes a previous convolution concatenation process, wherein features from a previous frame are concatenated with one or more tokens from a current frame in a channel dimension, where the features are identified prior to a convolutional step of processing of the previous frame.

9. The method as recited in claim 1, wherein the generating the set of second tokens further utilizes a post convolution concatenation process, wherein features from a previous frame are concatenated with one or more tokens from a current frame in a channel dimension, where the features are identified after a convolutional step of processing of the previous frame.

10. The method as recited in claim 1, wherein the generating the set of second tokens further utilizes a sequence concatenation process, wherein features from a previous frame are concatenated with one or more tokens from a current frame in a sequence dimension, where the features are identified prior to a convolutional step of processing of the previous frame.

11. The method as recited in claim 1, wherein the generating the set of second tokens further utilizes a cross-attention concatenation process, wherein continuous features from a previous frame are selectively attended and concatenated with one or more tokens from a current frame using a cross-attention layer after each attention layer in a decoder.

12. The method as recited in claim 1, further comprising:
freezing the video transformer tokenizer from further processing; and
training a generative model using the set of second tokens.

13. The method as recited in claim 12, further comprising:
decoding the set of second tokens using an autoregressive tokenizer using continuous features of a first frame of the frames of the video.

14. The method as recited in claim 13, further comprising:
training the generative model to predict the continuous features.

15. The method as recited in claim 12,
performing an autoregressive reconstruction, wherein continuous features are set to zero and unseen objects are encoded as discrete tokens.

16. The method as recited in claim 1, further comprising:
training a generative model using the set of second tokens, wherein the training occurs while the generating the set of second tokens is in progress.

17. A video tokenizer system, comprising:
a convolutional encoder configured to generate a first set of video tokens from a training video utilizing a convolutional tokenizer in a pixel space corresponding to a perceptual compression of frames of the training video;
a transformer encoder configured to generate a second set of video tokens from the first set of video tokens utilizing a video transformer tokenizer in a latent space corresponding to a semantic compression of the frames of the training video; and
an autoregressive convolutional decoder configured to generate output frames utilizing the second set of video tokens.

18. The video tokenizer system as recited in claim 17, further comprising:
a machine learning system configured to receive the second set of video tokens, update a machine learning model, and provide a trained tokenization model.

19. The video tokenizer system as recited in claim 17, wherein the second set of video tokens is used to train a video machine learning system.

20. A system, comprising:
a receiver configured to receive input parameters, wherein the input parameters include a video and operation parameters; and
one or more processors, configured to execute code to:
generate a set of first tokens of frames of a video using a convolutional tokenizer in a pixel space, wherein the set of first tokens corresponds to a perceptual compression of the frames of the video,
freeze the convolutional tokenizer from further processing when a last frame of the video has been tokenized in the set of first tokens, and
generate a set of second tokens from the set of first tokens using a video transformer tokenizer in a latent space, wherein the set of second tokens corresponds to a semantic compression of the frames of the video, and the set of second tokens is an encoding of the frames of the video into video tokens.

21. The system as recited in claim 20, further comprising:
a transmitter configured to communicate the set of second tokens as an output to a user or a second system.

22. The system as recited in claim 20, wherein the one or more processors is a machine learning system.

23. The system as recited in claim 20, wherein the one or more processors is one or more of a central processor unit (CPU) or a graphics processor unit (GPU).

24. A non-transitory computer-readable medium storing a series of operating instructions that directs a data processing apparatus when executed thereby to perform operations, the operations comprising:
generating a set of first tokens of frames of a video using a convolutional tokenizer in a pixel space, wherein the set of first tokens corresponds to a perceptual compression of the frames of the video;
freezing the convolutional tokenizer from further processing; and
generating a set of second tokens from the set of first tokens using a video transformer tokenizer in a latent space, wherein the set of second tokens corresponds to a semantic compression of the frames of the video, and the set of second tokens is an encoding of the frames of the video into video tokens.

25. The non-transitory computer-readable medium as recited in claim 24, further comprising:
decoding a current frame once the generating a set of second tokens for at least an immediately previous frame has completed, using causal attention layers and separate patchify layers for images and videos.

26. The non-transitory computer-readable medium as recited in claim 24, wherein the generating the set of second tokens utilizes features from at least one previous frame of the frames, where the features are identified from continuous latents before a tokenizer bottleneck is encountered in the generating of the set of first tokens for the at least one previous frame.
